(19) United States
(12) Patent Application Publication
(10) Pub. No.: US 2007/0030915 A1
(43) Pub. Date: Feb. 8, 2007

(54) Receiver Block Providing Signal Quality Information in a Communication System with Signal Constellation not Having multiple Symbols in Same Angle

(75) Inventors: Bijoy Bhukania, Bangalore (IN); Jawaharlal Tangudu, Bangalore (IN); Abhijit Patki, Bangalore (IN)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/161,460

(22) Filed: Aug. 4, 2005

(51) Int. Cl. H04L 5/12; H04L 27/10; H04L 27/22

(52) U.S. Cl. 375/261; 375/280; 375/332

(57) ABSTRACT

An aspect of the present invention provides signal quality information representing the angular deviations (i.e., based on the phase angle difference between the received symbol and the corresponding decoded symbol (i.e., selected symbol point in a signal constellation)). As a result, a relatively more accurate signal quality information is provided to external component at least in systems in which the signal constellation do not have multiple symbols in the same angle. The computational complexity may also be reduced as a result.

### BACKGROUND OF THE INVENTION

1. Field of the Invention

The present invention generally relates to communication systems and more specifically to a receiver providing signal quality information in a communication system with signal constellation not having multiple symbols in the same angle.

2. Related Art

Stream of data bits are often encoded using techniques such as phase shift keying (PSK), frequency shift keying (FSK), quadrature amplitude modulation (QAM), etc., to generate a corresponding sequence of transmitted symbols (actual symbols) with each symbol representing one or more data bits. Typically, to encode n-bits, 2n number of symbols are used.

The set of actual symbols used to encode data stream may be represented as points in a multi dimensional graph, generally referred to signal constellation. The co-ordinates of each point generally represent various parameters/characteristics (power, phase, amplitude, etc.) of the transmitted symbol.

Some constellations are characterized in that no two symbols are in the same angle (direction). For example, when using M-ary Phase Shift Keying (MPSK), M-symbols may be located on the periphery of a circle with an angular distance of 360/M between each pair of symbols. Similarly, in the case of quadrature amplitude modulation (4-QAM), the four symbols are located 90 degrees apart. The signal constellation of the actual symbols may be used to decode received symbols as described below.

In a common scenario, a sender system encodes a desired bit stream as multiple symbols, modulates the symbols using a carrier signal (up conversion), and transmits the carrier signal to a receiver system on a communication channel. The receiver system receives the modulated signal from the channel, demodulates (down conversion) the received signal to obtain a sequence of received symbols.

However, the characteristics of received symbols differ from the characteristic of the actual symbols due to factors such as noise and non-ideal receiver components (during transmission and demodulation at the receiver respectively). Hence the received symbols are generally mapped on to the signal constellation of the actual symbols, and a nearest actual symbol in the constellations is selected to decode the data bits.

The distance between the received symbol point and the selected transmitted symbol point may be viewed as an error (introduced in the path from the transmitting device to the receiving device). Generally the error is measured over a period of time to generate information (“signal quality information”) representing quality of the received signal. The signal quality information is generally used to control/adjust various parameters in the communication system to reliably communicate the desired information at all time.

The signal quality information may need to be generated while meeting one or more requirements. For example, the information may need to accurately represent the signal quality for the encoding technique. It may be desirable to compute the information with minimal complexity, in addition to reducing computational complexity in the manner in which the information is used by other components.

### BRIEF DESCRIPTION OF THE DRAWINGS

Various features of the present invention will be described with reference to the following accompanying drawings. In the drawings, like reference numbers generally indicate identical, functionally similar, and/or structurally similar elements. The drawing in which an element first appears is indicated by the leftmost digit(s) in the corresponding reference number.

FIG. 1 is a block diagram illustrating the details of an example environment in which various aspects of the present invention can be implemented.

FIG. 2 is a graph illustrating an example signal constellation of multi-phase shift keying (MPSK) with M=4 (QPSK).

FIG. 3 is a graph illustrating some of the disadvantages in a prior embodiment.

FIG. 4 is a flow-chart illustrating manner in which a receiver device processes an input signal according to an aspect of present invention.

FIG. 5 is a block diagram illustrating a manner in which signal quality computation may be performed in an embodiment of the present invention.

FIG. 6 is a block diagram illustrating a manner in which signal quality computation may be performed in an alternative embodiment of the present invention.

FIG. 7 is a block diagram of a digital processing system in which various features of the present invention are operative upon execution of corresponding software instructions.

### DETAILED DESCRIPTION

1. Overview

An aspect of the present invention provides signal quality information representing the angular deviations (i.e., based on the phase angle difference between the received symbol and the corresponding decoded symbol (i.e., selected symbol point in a signal constellation)). As a result, a relatively more accurate signal quality information is provided to external component at least in systems in which the signal constellation do not have multiple symbols in the same angle. The computational complexity may also be reduced as a result.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the invention.

2. Example Environment

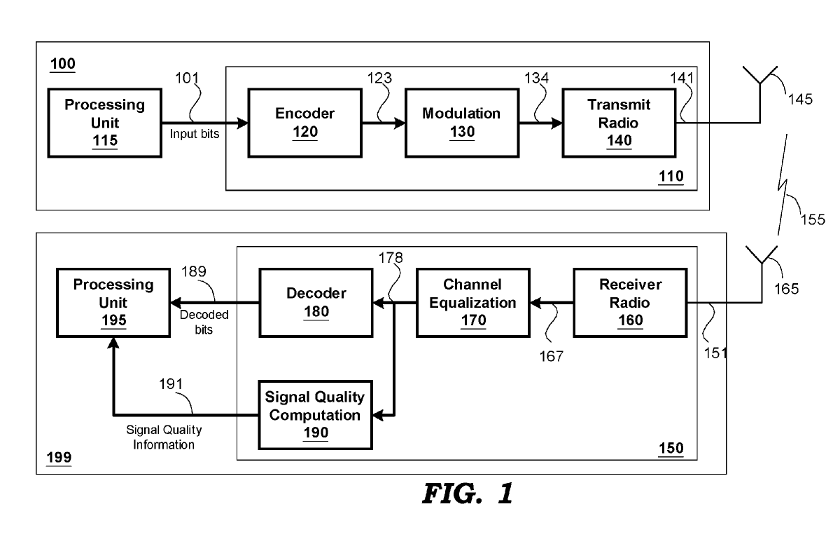

FIG. 1 is a block diagram illustrating the details of an example environment in which various aspects of the present invention can be implemented. The environment is shown containing transmitter device 100 and receiver device 199 connected by wireless network 155, with transmitter device 100 containing processing unit 115 and transmitter block 110, and receiver device 199 containing processing unit 195 and receiver block 150. Even though shown in different devices for illustration, transmitter block 110 and receiver block 150 would both be contained in each device. Each component is described in further detail.

Transmitter block 110 encodes digital data bits received on path 101 from a processing unit 115 in the form of symbols, and transmit the resulting symbols to receiver block 150. Receiver block 150 reproduces the digital data bits from the received symbols and determines the received signal quality. Both the reproduced digital data bits and signal quality information are respectively provided to processing block 195 on path 189 and 191.

Transmitter block 110 is shown containing encoder 120, modulation block 130, and transmit radio 140. Encoder 120 divides the bit stream received on path 101 into n-bit units, and generates one of M different values (M=2n, corresponding to M symbols of a signal constellation, as described below) corresponding to each n-bit unit. The resulting values are provided to modulation block 130 on path 123.

Modulation block 130 generates symbols representing each received value. In an embodiment implementing M-ary phase shift keying (MPSK), the symbols are generated by shifting the phase of a carrier signal by an angle (received value*360/M). For example MPSK modulator provides a zero phase shift to a carrier when a value 0 (corresponding to n zero bits) is received from encoder 110. A phase shift of 360/M is introduced when a received value equals 1 (corresponding a logic one in last bit of the n-bits).

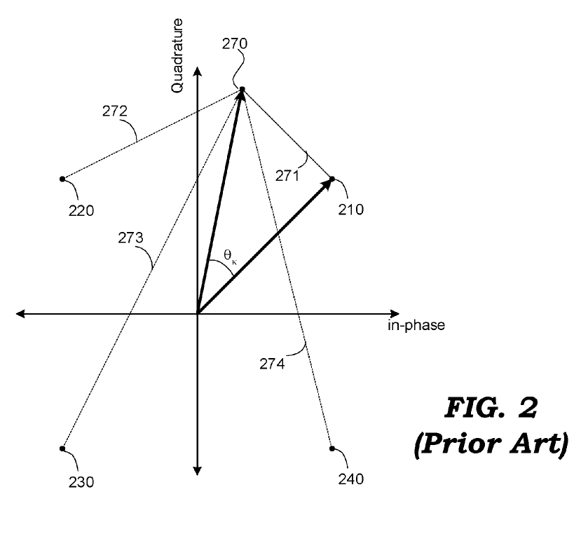

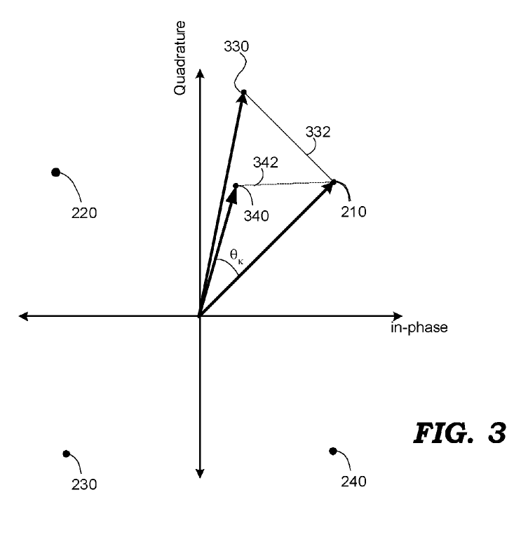

The signal constellation of transmitted symbols, generated by such MPSK modulators are located on the periphery of a circle with angular distance of 360/M between each pair of symbols (as described with respect to FIGS. 2 and 3 below in case of M=4). The symbols are provided on path 134 for transmission. Transmit radio 140 up-converts the received symbols by using a carrier signal and power amplifies the up-converted signal before transmitting the amplified signal using antenna 145.

Receiver 150 is shown containing receiver radio 160, channel equalization 170, decoder 180 and signal quality computation 190. Receiver radio 160 receives a signal through receive antenna 165 and down converts the received signal using a locally generated carrier signal. The down converted signal is provided on path 167 to channel equalizer 170.

Channel equalizer 170 performs various channel equalization techniques well known in relevant art to remove various errors due to multipath interferences, channel spread, etc., from the received signal. The channel equalization technique used generally depends on the characteristic of the channel. The channel equalized symbols are provided to decoder 180 and signal quality computation block 190 on path 178.

In this embodiment, the symbols provided on path 178 are viewed as the received symbols. However, symbols prior to channel equalization can also be viewed as received symbols in alternative embodiments. In such situations, the error value would generally be more than after appropriate channel equalization techniques.

Decoder 180 receives the sequence of (received) symbols on path 178 and maps each received symbol onto the signal constellation of the actual symbols. Decoder 180 then selects a nearest transmitted (actual) symbol from the location of received symbol for decoding digital data bit. Decoder 180 can be implemented using simple well-known blocks such as “slicer”. Alternatively, slicer can form part of a larger decoding logic which can implement complex approaches such as Viterbi decoding algorithm, well known in the relevant arts. Decoded digital data bits are provided on path 189.

Processing unit 195 processes the received digital data bits to provide various user applications such as telephone calls, data access, etc., in conjunction with processing unit 115. In addition, processing unit 195 uses the signal quality information to adjust various parameters (e.g., transmission power, switching to a different cell in case of mobile networks) of transmitter device 100 as well as within receiver device 199 (e.g., increase receiver sensitivity), as is well known in the relevant arts.

Accordingly, there is a general need for receiver block 150 to provide the signal quality information to processing unit 195. Various aspects of the present invention provide a convenient convention to provide the information, as well as to compute the same while reducing mathematical computations. The features will be clearer by understanding the manner in which decoder 180 generally decodes received symbols (in an embodiment( ), as described below with reference to FIG. 2.

3. Nearest Actual Symbol

FIG. 2 is a graph illustrating an example signal constellation of MPSK with M=4 (QPSK). X-axis and Y-axis respectively represent in-phase and quadrature components (magnitudes). The graph is shown containing points 210, 220, 230, 240 and 270. The X and Y coordinates of points 210, 220, 230 and 240 respectively corresponds to in-phase and quadrature magnitude of four actual symbols representing values 00,01, 10, and 11. Point 270 corresponds to a received symbol.

Lines 271, 272, 273 and 274 represent the distance between the received symbol point 270 and actual symbol points 210, 220, 230 and 240 respectively. The magnitude of distances may be computed using Euclidean formula well known in the relevant arts. Decoder 180 selects actual symbol 210 having the minimum distance.

Continuing with reference to FIG. 1, signal quality computation 190 generates data representing signal quality information and provides the information on path 191. As noted above, signal quality information represents the deviation of received symbols from the corresponding actual symbols transmitted from transmitter block 110.

The signal quality information is generated from the received symbols (received on path 178) and signal constellation of the actual symbols. According to a prior approach, the signal quality information is represented as a error vector magnitude (EVM), which is computed based on the Euclidean distances, noted above with respect to FIG. 2.

In one embodiment, EVM is computed based on the IEEE specification 802.11b, in which the Euclidean distance between received symbols and the corresponding selected actual symbols is computed over a period of time and averaged to generate EVM as:

$$EVM = log [ \frac{1}{N} {\sum }_{k = 1}^{N} {( {Y}_{k} - {X}_{k} )}^{2} ] \qquad Equation ( 1 )$$

wherein Yₖ and Xₖ respectively represents a k^{th} received symbol and the selected symbol, and N represents the number of symbols received in the period of interest. The computed EVM represents a signal quality in decibel unit (log operation may be performed base 10). However, such approach may have several disadvantages. One disadvantage with such an approach is described below with respect to FIG. 3.

4. Disadvantage(s) with a Prior Embodiment

FIG. 3 is a graph containing actual symbol points 210, 220, 230 and 240, and received symbols 330 and 340 corresponding to actual symbol 210 received at two different time points. Lines 332 and 342 represent the distance computed between respective received symbols and selected actual symbol.

It may be appreciated that, in MPSK encoding each symbol is encoded with a phase difference, hence received symbols 330 and 340 at two time points have the same phase information implying same signal quality. However due to the approach described above with respect to Equation (1), the signal quality at two time points represents different amplitude values (due to the operation of automatic gain control) indicating a (substantial) change in the received signal quality.

As may be appreciated, the Euclidean distances would provide an inaccurate view of the signal quality when using such signal constellations. In addition, computation of Euclidean distance adds to the computation complexity, in view of the Squaring operation for each coordinate. Various aspects of the present invention overcome such disadvantages, as described below in further detail.

5. Representing Signal Quality Information

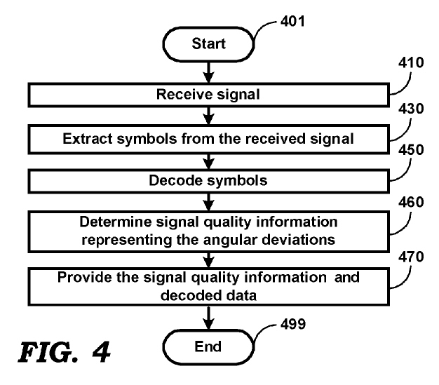

FIG. 4 is a flowchart illustrating the manner in which a receiver device processes an input signal according to an aspect of present invention. The flowchart is described substantially with respect to FIG. 1 for illustration. However, the approach(es) can be implemented in other environments and devices as well. The flow chart begins in step 401 and control passes to step 410.

In step 410, receiver device 150 receives a signal from a transmitter device (110). The signal may be received through antenna in case of radio signal or through a communication path such as cables or optic fiber.

In step 430, receiver device 150 extracts symbols from the received signal. Symbols may be extracted by performing operations such as down conversion, channel decoding, channel equalization etc., to complement the operations performed at the corresponding transmitter.

In step 450, receiver device 150 decodes symbols to generate digital data bit(s) corresponding to each received symbol. Decoding may be performed by obtaining various parameters such as phase, amplitude, etc., and the parameters are then mapped on to a corresponding actual symbol constellation. The value of the nearest actual symbol represented as digital bits (as described above with respect to FIG. 2) and provided as decoded digital data bits.

In step 470, receiver device 150 determines signal quality information representing the angular deviations between the selected actual symbols and the corresponding received symbols. Various mathematical operations may be performed on the angular deviations (difference of the angle of the received symbol and the actual symbol in the constellation map) of a number of received symbols to determine the signal quality information.

In step 490, receiver device 150 provides the signal quality information and decoded data to processing unit 195 on separate paths. The signal quality information can be used by processing unit 195, for example, as described above. The flow chart ends in step 499.

By observing FIG. 3, it may be appreciated that the signal quality information is more accurately represented by angular deviations in situations in which no two symbols are in the same angle in a signal constellation (such as in QPSK). Accordingly, the signal quality information provided according to the above approach may provide a measure of the errors more accurately.

It should be appreciated that the signal quality information can be computed using several approaches using various parameters representing (providing angle information) the angular deviations. The manner in which the signal quality information may be determined is described below with examples.

6. Computation of Signal Quality Information

An example approach to computation of signal quality information will be clearer by first understanding the manner in which the angular deviations can be represented by various parameters. Accordingly, the parameters are described first below.

The angular deviation between the received symbol Xₖ and the selected actual symbol sₖ is represented as θₖ(as shown in FIG. 3). However, when the symbols are represented using complex exponential representation, each of a magnitude of real term (γₖ) and the magnitude of the imaginary term (α) of the product of two symbols contains information on the angle between the two symbols (angular deviation).

For example, magnitude of real term γₖ=R[Xₖ*sₖ]=|sₖ||Xₖ cos θₖ, wherein |sₖ| and |xₖ| represents the magnitude (energy) of the actual symbol and the received symbol respectively. As a result, the parameter γₖ is proportionate to cosine of the angle between the symbols. Similarly, the magnitude of imaginary term αₖ=I[xₖ*sₖ]=|sₖ||xₖ| sin θₖ (αₖ=Ksin θₖ), thereby representing the angle with sinusoidal relation.

Parameters θₖ, αₖ, γₖ etc., may be computed from the received symbols. However, the phase angle information is often computed in receiver devices to provide corrections to the received signal. For example, a receiver implemented according to the 802.11b with 5.5 and 11 Mbits/s data rate, may provide angle information in the form of a αₖ, and a receiver implemented according to specifications of 802.11b with data rates of 1 and 2 Mbits/s may provide angle information in the form of θₖ.

As a result, the available θₖ, αₖ, γₖ parameters may be readily used to compute the signal quality information, thereby reducing further any additional hardware (or computational) requirements. An example approach to compute signal quality information (using such parameters) is described below.

Parameter αₖ is used to compute the signal quality as follows:

$$evm = - log [ \frac{1}{N} {\sum }_{k = 1}^{N} {α}_{k} ] \qquad equation ( 2 )$$

Alternatively, EVM may be computed from multiple successive symbols similar to in Equation 1, except that cos θₖ is used instead of the Euclidean distance:

$$evm = - log [ 1 - \frac{1}{N} {\sum }_{k = 1}^{N} cos {θ}_{k} ] \qquad equation ( 3 )$$

In comparison to Equation (1), it may be appreciated that the complexity of computations is reduced to an extent of computation of square in both Equations (2) and (3).

As may be appreciated from FIG. 3 above, the signal quality information is more accurately represented when based on angular deviation. In other words, when Equation (2) or (3) is used, the error magnitude would be substantially equal in case of received symbol points 330 and 340 of FIG. 3. Due to such accurate representation, processing unit 195 may adjust various parameters (e.g., transmission power, switching to a different cell in case of mobile networks) of transmitter device 100 as well as within receiver device 199 (e.g., increase receiver sensitivity) accurately.

The signal quality information may be computed based on angular deviations using one of several approaches. An example implementation of signal quality computation block 190 providing signal quality information according to equation 2 is described below.

7. Example Implementations

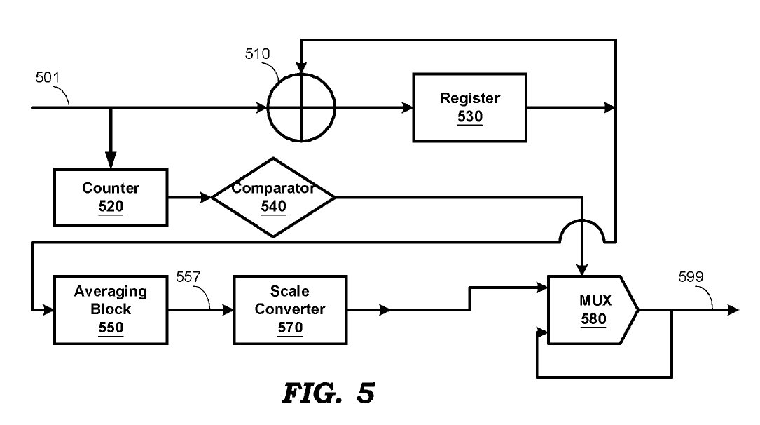

FIG. 5 is block diagram illustrating a manner in which signal quality computation block 190 is implemented to provide a signal quality information according to equation 2 in one embodiment. Signal quality computation block 190 is described assuming αₖ is provided by decoder 180 (on path 501). The block diagram is shown containing adder 510, register 530, counter 520, comparator 540, averaging block 550, scale converter 570, and multiplexer (MUX) 580. Each block is described below in further detail.

Adder 510 and register 530 together are operated as an accumulator, which adds N successive αₖ values and provide the accumulated result (of equation 2) to averaging block 550. Averaging block 550 divides the accumulated result by N. The division may be performed by dropping the last log₂(N) bits from the binary representation of the accumulated value. Thus, the output (557) of averaging block 550 equals

$$\frac{1}{N} \sum {α}_{k} .$$

Scale converter 570 receives the output of averaging block 550 and provides a decibel equivalent value of the received input value. Decibel convertion may be performed according to

$$M \times log ( \frac{average}{P} ) \qquad Equation ( 4 )$$

wherein, M and P represents arbitrary numbers, log represents a logarithmic to base 10 operation, and average represents value received on path 557. The goal is generally to arrive at a metric which monotonically increases or decreases with channel quality. In one embodiment the decibel convertion is performed according to:

$$\frac{22}{48} \times ( {log}_{10} \frac{average}{128} ) \times 128 \qquad Equation ( 4 a )$$

Counter 520 counts the number of αₖ values accumulated in register 530. Comparator 540 generates one logical value (1) when the counter value equals an integer which is a power of 2 (e.g., 2, 4, 8, 16, 32, . . . , etc.), and the other logical value otherwise. The comparator output is provided as a select input of MUX 580.

The output of the scale converter 570 is provided to one of the input terminal (logic 1) of MUX 580 and other input terminal of MUX 580 is provided from the output of the MUX 580. Due to the operation of comparator 540, the computed signal quality information is updated on output path 599 selectively at the reception of every 2^{Qth} (wherein Q is an integer) received value of αₖ.

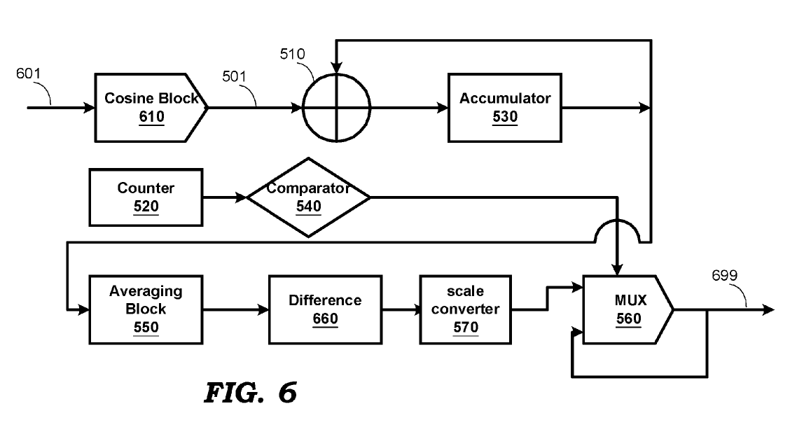

Thus, the output on path 599 represents the signal quality information computed according to Equation (2) described above. Similar approach can be used in computing the signal quality information according to Equation (3) as well, as described with respect to FIG. 6. Blocks of similar characteristics are repeated (with same label and reference number) in FIG. 6, and only the differences in relation to FIG. 5 are described for conciseness.

Cosine block 610 computes a cosine value of the θₖ values received on path 601. The output of cosine block 610 is provided on path 501 of FIG. 6. Difference block 660 is shown provided receiving the output of average block 550. Different block 660 subtracts the received value from 1. The resulting output is provided to scale converter 570. Due to such a configuration, path 699 would contain the EVM values according to Equation (3), and the values are updated every 2^{Qth} θₖ value.

It should be appreciated that the approaches described above can be implemented in the form of a combination of one or more of software, hardware and firmware. In general, when throughput performance is of primary consideration, the implementation is provided more in the form of hardware, and when cost is of primary consideration the implementation is performed more in the form of software. An embodiment of signal quality computation block 190 may be implemented substantially in the form of software as described below.

8. Software Implementation

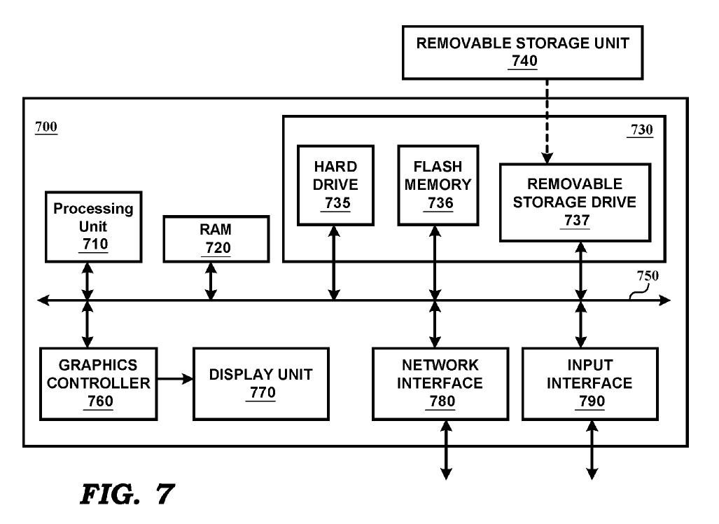

FIG. 7 is a block diagram of computer system 700 illustrating an example system for implementing signal quality computation block 190 described above. Computer system 700 may contain one or more processors such as central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present invention (by performing tasks corresponding to various approaches described above). CPU 710 may contain multiple processing units (including processing unit 195), with each processing unit potentially being designed for a specific task. Alternatively, CPU 710 may contain only a single processing unit. RAM 720 may receive instructions from secondary memory 730 using communication path 750.

Graphics controller 760 generates display signals (e.g., in RGB format) to display unit 770 based on data/instructions received from CPU 710. Display unit 770 contains a display screen to display the images defined by the display signals. Input interface 790 may correspond to a key-board and/or mouse, and generally enables a user to provide inputs. Network interface 780 enables some of the inputs (and outputs) to be provided on a network.

Secondary memory 730 may contain hard drive 731, flash memory 736 and removable storage drive 737. Secondary storage 730 may store the software instructions (which perform the computations described above) and data, which enable computer system 700 to provide several features in accordance with the present invention. Some or all of the data and instructions may be provided on removable storage unit 740, and the data and instructions may be read and provided by removable storage drive 737 to CPU 710. Floppy drive, magnetic tape drive, CD-ROM drive, DVD Drive, Flash memory, removable memory chip (PCMCIA Card, EPROM) are examples of such removable storage drive 737.

Removable storage unit 740 may be implemented using medium and storage format compatible with removable storage drive 737 such that removable storage drive 737 can read the data and instructions. Thus, removable storage unit 740 includes a computer readable storage medium having stored therein computer software and/or data. An embodiment of the present invention is implemented using software running (that is, executing) in computer system 700.

In this document, the term “computer program product” is used to generally refer to removable storage unit 740 or hard disk installed in hard drive 731. These computer program products are means for providing software to computer system 700. As noted above, CPU 710 may retrieve the software instructions, and execute the instructions to provide various features of the present invention.

9. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A receiver system processing an input signal encoding symbols according to a signal constellation containing a plurality of symbol points, said receiver system comprising:
a decoder receiving a plurality of received symbols encoded in said input signal, and selecting one of said plurality of symbol points corresponding to each of said plurality of received symbols;
a signal quality computation block generating a signal quality information representing a plurality of angular deviations, wherein each angular deviation represents a phase angle difference between the received symbol and the corresponding selected symbol; and
a processing block receiving said signal quality information.

2. The receiver system of claim 1, wherein no two of said plurality of symbol points are in a same angle in said signal constellation.

3. The receiver system of claim 2, wherein said signal constellation corresponds to multi-phase shift keying (MPSK).

4. The receiver system of claim 2, wherein said signal quality computation block computes said signal quality information according to:
$$- log [ \frac{1}{N} {\sum }_{k = 1}^{N} {α}_{k} ]$$
wherein N represents the number of received symbols based on which said signal quality information is computed, αₖ is proportionate to sin θₖ, θₖ represents said angular deviation between each received symbol and corresponding selected symbol.

5. The receiver system of claim 2, wherein said signal quality computation block computes said signal quality information according to:
$$- log [ 1 - \frac{1}{N} {\sum }_{k = 1}^{N} cos {θ}_{k} ]$$
wherein N represents the number of received symbols based on which said signal quality information is computed, θₖ represents said angular deviation between each received symbol and corresponding selected symbol.

6. An apparatus for processing an input signal encoding symbols according to a signal constellation containing a plurality of symbol points, said apparatus comprising:
means for receiving a plurality of received symbols encoded in said input signal;
means for selecting one of said plurality of symbol points corresponding to each of said plurality of received symbols; and
means for generating a signal quality information representing a plurality of angular deviations, wherein each angular deviation represents a phase angle difference between the received symbol and the corresponding selected symbol.

7. The apparatus of claim 1, wherein no two of said plurality of symbol points are in a same angle in said signal constellation.

8. The apparatus of claim 7, wherein said signal constellation corresponds to multi-phase shift keying (MPSK).

9. The apparatus of claim 7, wherein said signal quality information is computed according to:
$$- log [ \frac{1}{N} {\sum }_{k = 1}^{N} {α}_{k} ]$$
wherein N represents the number of received symbols based on which said signal quality information is computed, αₖ is proportionate to sin θₖ, θₖ represents said angular deviation between each received symbol and corresponding selected symbol.

10. The apparatus of claim 7, wherein said signal quality information is computed according to:
$$- log [ 1 - \frac{1}{N} {\sum }_{k = 1}^{N} cos {θ}_{k} ]$$
wherein N represents the number of received symbols based on which said signal quality information is computed, θₖ represents said angular deviation between each received symbol and corresponding selected symbol.

11. A method of processing an input signal encoding symbols according to a signal constellation containing a plurality of symbol points, said method comprising:
receiving a plurality of received symbols encoded in said input signal;
selecting one of said plurality of symbol points corresponding to each of said plurality of received symbols;
generating a signal quality information representing a plurality of angular deviations, wherein each angular deviation represents a phase angle difference between the received symbol and the corresponding selected symbol.

12. The method of claim 1, wherein no two of said plurality of symbol points are in a same angle in said signal constellation.

13. The method of claim 12, wherein said signal constellation corresponds to multi-phase shift keying (MPSK).

14. The method of claim 12, wherein said signal quality information is computed according to:
$$- log [ \frac{1}{N} {\sum }_{k = 1}^{N} {α}_{k} ]$$
wherein N represents the number of received symbols based on which said signal quality information is computed, αₖ is proportionate to sin θₖ, θₖ represents said angular deviation between each received symbol and corresponding selected symbol.

15. The method of claim 12, wherein said signal quality information is computed according to:
$$- log [ 1 - \frac{1}{N} {\sum }_{k = 1}^{N} cos {θ}_{k} ]$$
wherein N represents the number of received symbols based on which said signal quality information is computed, θₖ represents said angular deviation between each received symbol and corresponding selected symbol.
